(19) United States
(12) Patent Application Publication
(10) Pub. No.: US 2022/0081279 A1
(43) Pub. Date: Mar. 17, 2022

(54) SMART VAPOUR RETURN PUMP SYSTEM

(71) Applicant: MEPSAN PETROL CIHAZLARI SAN. VE TIC. A.S., Konya (TR)

(72) Inventor: Mehmet Levent BULGURLU, Konya (TR)

(73) Assignee: MEPSAN PETROL CIHAZLARI SAN. VE TIC. A.S., Konya (TR)

(21) Appl. No.: 17/419,738

(22) PCT Filed: Apr. 17, 2019
(86) PCT No.: PCT/TR2019/050260

§ 371 Date: Jun. 30, 2021

(30) Foreign Application Priority Data
Dec. 31, 2018 (TR) 2018/21398

(51) Int. Cl. B67D 7/04

(52) U.S. Cl. CPC B67D 7/0486

(57) ABSTRACT

A smart vapour return pump system is integrated into gasoline hydraulic units at gas stations, absorbing petrol vapour deposited in the fuel tank with vapour return pump when fuel nozzle is placed into the fuel tank, calculating vapour quantity that is absorbed, obtaining various speeds by using DC motor, using polymer-coated magnetic pallet system and having the whole electronic control unit on a single body at the vapour return pump. The smart vapour return pump system includes a motor shaft, a rotor liner, a rotor, a stator, a motor magnet, a 4 pole magnet, a pallet roller, a motor housing, a motor housing cover, a motor casing, bearings, inner segments, rotor shaft pin, motor shaft pin, O-rings, flame holder, flame holder housing, pump cover, circuit board, junction cover, motor holder plate, rotor lower plate, rotor upper late, gland pressure rubber, gland plate, and motor shaft seal.

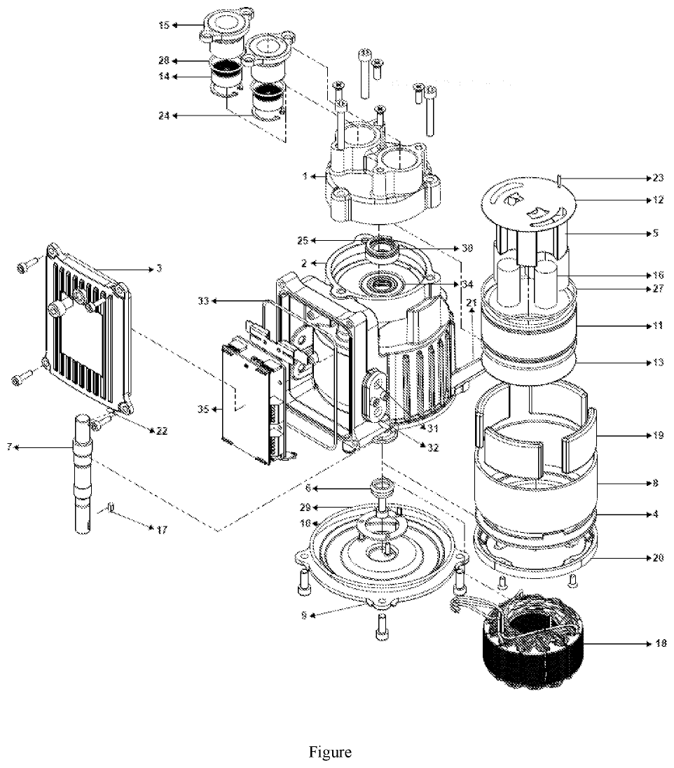

### CROSS REFERENCE TO THE RELATED APPLICATIONS

This application is the national phase entry of International Application No. PCT/TR2019/050260, filed on Apr. 17, 2019, which is based upon and claims priority to Turkish Patent Application No. TR2018/21398, filed on Dec. 31, 2018, the entire contents of which are incorporated herein by reference.

### TECHNICAL FIELD

This invention is about the smart vapour return pump system that is integrated into gasoline hydraulic units at gas stations, absorption of petrol vapour deposited in the fuel tank with vapour return pump when fuel nozzle is placed into the fuel tank, calculation of vapour quantity that is absorbed, obtaining various speeds by using direct current (DC) motor, using polymer-coated magnetic pallet system and has the whole electronic control unit on a single body at the vapour return pump.

### BACKGROUND

Fossil fuels such as coal, natural gas and fuel oil are organic substances formed under high pressure and rich in carbon dioxide content.

The CO₂ gas released as a result of the use of these fuels mixes with the atmosphere. This event, which is normally a part of the carbon cycle, causes the amount of CO₂ in the atmosphere to rise to higher than normal levels with the increase in the use of fossil fuels.

The major components of air oxygen and nitrogen reflect lights of the sun with visible wavelengths and absorb some of the ultraviolet radiation. (absorbs). Sunlight that can reach the surface of the earth is transformed into heat by being absorbed by the earth. This heat causes atomic vibration and infrared radiation. These infrared radiations are not absorbed by oxygen or nitrogen gas. However, CO₂ and CFC (chlorofluorocarbon) gases in the air absorb some of the infrared radiation, partly and preventing them from escaping from the atmosphere. This absorption causes the atmosphere to warm up. As a result, the earth heats up like the inside of a car parked in the sun. This effect is called the “greenhouse effect”.

The greenhouse effect will change the average temperature of the earth surface, so in the long turn it may cause significant problems like climate change, glacier melting, season creep and arid agricultural lands.

Greenhouse gas and hydrocarbon emissions are being tried to be limited by several worldwide regulations. Most of these emissions consist of volatile hydrocarbon compounds that are caused by liquid petroleum production, transportation and other applications. Several institutions in the world are struggling to limit emissions of hydrocarbon and chemical compounds in order to decrease air pollution and protect human health. US based EPA and Germany based TA-Luft are major institutions among them and there are EC instructions for oil terminals.

Gasoline is a fuel that is thinner, less oily and more volatile (easily vapourised) than diesel oil. Gasoline has a very low boiling point of 32° C. so it can rapidly evaporates at all temperatures.

Gasoline: in vehicle tanks vapourises in time so petrol vapour (hydrocarbons) always exists in capacity of the tank that is not fillet with liquid. When fuel is to be delivered to gasoline-powered vehicle and fuel lid is opened, petrol vapour diffuses to the air quickly from the vehicle tank.

Vapour return systems pay for itself in a short time. If a station does not have vapour return system 1.5 grams of gasoline go into the atmosphere for every 1 litre filled during refueling.

In Turkey and in the world, Directive 94/63/EC contains provisions for storing gasoline and decreasing release of petrol vapours during transferring from terminals to stations and Directive 2009/126/EC contains provisions for decreasing release of petrol vapours during refueling of motor vehicles in gas stations. According to the regulations of the Turkish ministries of European Union and Environment, the petrol vapour should be absorbed at a certain efficiency and sent back to the station tank via a return line. Vapour return system is designed to catch petrol vapour which is harmful to the environment and human health and to decrease hydrocarbon emissions. Vapour return systems prevents harmful fuel vapours to go into the atmosphere.

United States of America patent application U.S. Pat. No. 5,038,838 mentions return pump system. Here, the system has a quite complicated structure. The vapour counter, electronic system and pump mechanism are at different parts and its structure is quite complicated. So production complexity and after that time loss and difficulties during breakdown and maintenance occurs.

The patent WO2004080884 mentions the return pump system in the world. In this system the structure is again very complicated. The gas-metre, electronic system and pump mechanism are at different parts and its structure is quite complicated. Again, production complexity and after that time loss and difficulties during breakdown and maintenance occurs.

Aforementioned facts show that need for a system on the gasoline pump that calculates the amount of vapour in the gas tank it absorbs and enables to add the same amount of gas to the tank via gasoline pump and has the whole electronic control unit on a single body at vapour return pump, has an engine system that can control speed, easy to maintain and does not break down easily is obvious.

### SUMMARY

The pump that is integrated into gasoline hydraulic units at gas stations, absorption of petrol vapour deposited in the fuel tank with vapour return pump when fuel nozzle is placed into the fuel tank, calculation of vapour quantity that is absorbed, obtaining various speeds by using DC motor, using polymer-coated magnetic pallet system and has the whole electronic control unit on a single body at the vapour return pump is the smart vapour return pump system and its features are absorption of petrol vapour occurs in the gas tank and preventing it from emission to environment with smart vapour system, decreasing the harm to environment, decreasing fuel loss, uniting the whole electronic control unit of the vapour return pump system on a single body, being a small and compact system, enabling easier repair and maintenance, enabling speed control form the engine thanks to its DC motor, having thermoplastic polymer covered magnetic pallet system, easily integrate to and usable by fuel dispensers of different producers.

The smart vapour return pump system catches harmful petrol vapours and decreases hydrocarbon emissions. Therefore, it prevents harmful fuel vapours from going into the atmosphere. It protects the environment and human health.

A station that does not have vapour return system, 1.5 grams of gasoline goes to the atmosphere for every 1 litre filled during refueling. It means that 75 grams of gasoline go to the atmosphere when selling 50 litres. When 75 grams of petrol vapour is condensed, 100 ml of gasoline is obtained. This amount of gasoline cause a quite high amount of loss at in the long run. Regaining that loss is very beneficial particularly for the countries that fuel is sold with high prices.

Vapour return pump that is used in the smart vapour return pump system has a united electronic control unit on a single body. It reduces the area that vapour return pump will cover on the smart vapour return pump system. In case of breakdowns, it offers advantages of easiness of repair for service givers, decreased cost of cabling, installation and production for producers.

Proportional valves of current systems are not used in the smart vapour return pump system. Instead, amount of fuel absorbed can be more precisely controlled by changing pump speed with Brushless DC Engine. With variable-speed motor, instant proportion to flow rate of selling can be ensured. More efficient and effective vapour absorption at low speeds can be ensured.

Thermoplastic polymer covered magnetic pallet system of high technology that is resistant to petrol vapour is used in the smart vapour return pump system.

The smart vapour return pump system can be integrated to current fuel dispensers of other producers and technologies since it accommodates all units on a single body. It can communicate with the main service provider or the main server via a single cable outlet from the electronic control unit on it.

The smart vapour return pump system can communicate with vapour-metres and has self-calibration feature when used with a vapour-metre.

### BRIEF DESCRIPTION OF THE DRAWINGS

FIGURE is a representative view of the invention. In the FIGURE:
1 Pump cover
2 Motor Casing
3 Junction Cover
4 Motor Housing Cover
5 Rotor
6 Motor Shaft Bushing
7 Motor shaft
8 Motor housing
9 Motor Cover
10 Motor holder
11 rotor liner
12 Rotor Upper Plate
13 Rotor Lower Plate
14 Flame Holder
15 Flame Holder Housing
16 Pallet Roller
17 Motor Shaft Pin
18 Stator
19 Motor Magnet
20 4 Pole Magnet
21 Rubber Pads
22 Rotor Shaft Pin
23 Rotor Liner Shim
24 Flame Holder Inner Segment
25 Inner Segment
26 Bearing 6001
27 Rotor Liner O-ring
28 Flame Holder O-ring
29 Motor Lower Cover O-ring
30 Bearing 6902
31 Gland Pressure Rubber
32 Gland Plate
33 Junction Cover O-ring
34 Motor Shaft Seal
35 Circuit Board

The drawings described herein are for illustration purposes only and are not intended to limit the scope of the parts that constitute the invention in any way.

### DETAILED DESCRIPTION OF THE EMBODIMENTS

The invention which is about the smart vapour return pump system that is integrated into gasoline hydraulic units at gas stations, absorption of petrol vapour deposited in the fuel tank with vapour return pump when fuel nozzle is placed into the fuel tank, calculation of vapour quantity that is absorbed, obtaining various speeds by using DC motor, using polymer-coated magnetic pallet system and has the whole electronic control unit on a single body at the vapour return pump generally includes a Motor Shaft (7), a Rotor liner (11), a Rotor (5), a Stator (18), a Motor magnet (19), a 4 pole magnet (20), a Pallet roller (16), a Motor housing (8), a Motor housing cover (4), a Motor casing (2), bearings (26, 30), inner segments (25, 24), Rotor shaft pin (22), Motor shaft pin (17), O-rings (33, 29, 28, 27), Flame holder (14), Flame holder housing (15), Pump cover (1), Circuit Board (35), Junction cover (3), Motor holder plate (10), Rotor lower plate (13), Rotor upper late (12), gland pressure rubber (31), Gland plate (32), Motor shaft seal (34).

The smart vapour return pump system is based on the principle that; stator (18), motor magnet (19), motor housing (8), motor housing cover (4) and 4 pole magnet (20) connections are driven by circuit board and create a torque (Brushless Dc Motor) and this torque power is transmitted to the pump part that includes rotor (5), rotor liner (11), pallet roller (16), rotor lower plate (13), rotor upper plate (12), pump cover (1) and flame holders (14) via motor shaft (7) and motor shaft pin (17) and transmitted torque power creates a vacuum, created vacuum absorbs petrol vapour inside vehicle tanks and discharges to fuel tanks in stations.

Pump cover (1) provides the necessary enclosed volume in order to enable torque that is transmitted via motor shaft (7) to create vacuum on the pump part that includes rotor (5), rotor liner (11) and pallet rollers (16).

Motor casing (2) provides support in bearings, sealing and isolation from outer environment for the system. It provides sealing and isolation from environment for Junction cover (3), circuit board (35).

Motor housing cover (4) enables motor housing (8) to transmit power when rotating to motor shaft (7) with the help of motor shaft pin (17). Rotor (5) enables to create vacuum with the help of rotor liner (11), pump cover (1) and pallet rollings (6) as a result of transmitting of the torque that occurs in motor shaft (7) via rotor shaft pin (22).

Motor shaft bushing (6) prevents pump cover (1) to strain SS 6001 bearing (26) when connecting to it and enables it to decrease friction. Motor shaft (7) provides the surface that is needed for proper placement of motor magnets (19) and proper running of DC motor. Motor cover (9) enables motor to be isolated from outer environment. Motor holder plate (10), holds Stator (18) on motor body (2) in a proper way.

Rotor liner (11), creates the necessary space for rotor (5) to create the vacuuming Rotor upper plate (12) provides the necessary section in order to create the vacuum between rotor (5) and pump cover (1). Rotor lower plate (13) provides the minimum friction power for rotor (5) to rotate without rubbing against motor body (2).

Flame holder (14) enables that the flame does not go out and it is isolated inside the pomp in case of a possible combustion at the pump part. Flame holder housing (15) enables flame holder (14) to be fit onto pump cover properly and accurately.

Pallet roller (16) provides necessary enclosed spaces in order to have the vacuum between rotor (5) and rotor line (11). Motor shaft pin (17) enables transmitting of torque from motor housing cover (4) to motor shaft (7). Stator (18) creates magnetic power with help of motor magnets (19) and 4 pole magnet (20). magnet (19), creates magnetic power with help of Stator (18) and 4 pole magnet (20). 4 Pole Magnet (20) creates magnetic power with help of stator (18) and motor magnet (19). Rubber pads (21) prevents or decreases possible vibrations that occur on fuel dispenser that the Smart Vapour Return Pump System is connected.

Rotor shaft pin (22) transmits torque from motor shaft (7) to rotor (5). Rotor liner shim (23) fastens rotor liner (11) between motor body (2) and pump cover (1) and locates it. Fire Holder Inner Segment (24) fastens fire holders (14) into fire holder housing (15). Inner segment (25) fastens bearings (26, 30) after they are installed on motor body (2). Bearing 6001 (26) provides bedding for motor shaft (7) into the BLDC part of motor body (2). Rotor liner O-ring (27) prevents leakage from rotor liner (11) to the inner and outer parts of the pump part. Flame holder O-ring (28), enables sealing between flame holder housing (15) and plump cover (1). Motor lower cover O-ring (29) enables sealing between motor body (2) and motor cover (9). Bearing 6902 (30) provides bedding for motor shaft (7) into the pump part of motor body (2). Gland pressure rubber (31) enables electrical connection cables of the smart vapour return pump circuit board (35) to be transmitted from pump body (2) properly and isolated from outer environment. Gland plate (32) enables gland pressure rubber (31) to be connected to motor body (2). Junction cover O-ring (33) enables sealing between junction cover (3) and Motor Body (2). Motor shaft seal (34) provides sealing for the pump part. Circuit board (35), controls motor's rotation.

What is claimed is:

1. A smart vapour return pump system, comprising an on-board circuit, wherein the on-board circuit enables instant proportion to a fuel selling rate received from a fuel dispenser electronic card and is configured to communicate;
an on-board electronic card controls a motor speed and enables an equivalent amount of gasoline absorption to flow rate of fuel sold;
a motor body rotates at various speeds and absorbs petrol vapour at various flow rates without requiring any proportional valves with a brushless direct current (DC) motor;
a thermoplastic polymer covered magnetic pallet system of high technology is resistant to petrol vapour in the smart vapour return pump system; and
a vapour return pump is used in the smart vapour return pump system, wherein the vapour return pump comprises a junction cover, wherein the junction cover enables a whole electronic control unit to exist on a single body.
